(19) United States
(12) Patent Application Publication
(10) Pub. No.: US 2025/0172920 A1
(43) Pub. Date: May 29, 2025

(54) METHOD, DEVICE, SYSTEM, COMPUTER PROGRAM AND COMPUTER PROGRAM PRODUCT FOR ASCERTAINMENT OF PROCESS-RELATED ENERGY CONSUMPTION INFORMATION FOR A PLURALITY OF AUTOMATED PROCESSES

(71) Applicant: Siemens Aktiengesellschaft, München (DE)

(72) Inventors: Yi Zhu, Kümmersbruck (DE); Dieter Steindl, Poppenricht (DE)

(21) Appl. No.: 18/961,884

(22) Filed: Nov. 27, 2024

(30) Foreign Application Priority Data
Nov. 27, 2023 (DE) 10 2023 211 826.2

(51) Int. Cl. G05B 19/05

(52) U.S. Cl. CPC G05B 19/058

(57) ABSTRACT

A method includes the low-complexity ascertainment of process-related energy consumption information for a plurality of automated processes based on measurement data which have been recorded for all of the processes. The energy consumption profile of the plurality of processes is matched to sequence information of the individual processes and changes in the energy consumption of the plurality of processes are assigned to the individual processes based on the sequence information thereof. Energy consumption information for the individual processes is then determined based on changes in the energy consumption of the plurality of processes assigned to the respective processes. A device, a system, a computer program and a computer program product are also provided.

### CROSS-REFERENCE TO RELATED APPLICATION

This application claims the priority, under 35 U.S.C. § 119, of German Patent Application DE 10 2023 211 826.2, filed Nov. 27, 2023; the prior application is herewith incorporated by reference in its entirety.

### FIELD AND BACKGROUND OF THE INVENTION

The invention relates to a method, a device, a system, a computer program and a computer program product for ascertaining process-related energy consumption information for a plurality of automated processes.

Energy sustainability places high demands on energy transparency, which must be broken down to the level of individual processes executed by a device. Knowing how and how much energy a process consumes is critical to ascertaining the potential for increasing energy efficiency and reducing CO2 emissions. Industry is one of the most energy-intensive fields of application placing high demands on energy saving and energy efficiency.

One option for ascertaining consumption at the level of individual processes is direct measurement, that is to say at least one dedicated sensor (usually a current sensor, possibly supplemented by a voltage sensor) is provided for each process, the sensor collecting the relevant data for that process. That approach has the disadvantage of a high degree of outlay, not only in terms of the costs of installing and maintaining the sensors, but also in terms of the energy consumption thereof. That concept of direct measurement is also referred to as intrusive load monitoring.

In addition, there is the option of installing only one measuring device to collect all of the current and voltage data from a central measurement point that is connected to all devices. Algorithms based on the characteristic behavior of the devices are used to identify the device fingerprint in the energy-relevant data and break down the total energy consumption to the device level. Modern solutions are based on building device models which are trained by using a database containing the typical energy-relevant data of the individual devices. That requires extensive data collection for each type of device through direct measurements. The applicability of those solutions is significantly restricted in industrial applications, since the variety of devices in industry is very wide, especially in manufacturing processes. Those solutions, which are based on the typical device behavior, the so-called “ground truth” of the devices (that is to say data that enables the quality of models of the device to be checked), can therefore scarcely be generalized for industry. In addition, recording the ground truth is often difficult for the production lines due to the high degree of compatibility of the equipment and the high costs caused by production interruptions. That approach is associated with a type of method also known as “non-intrusive load monitoring” and is abbreviated as NILM. An example of such a procedure is described by International Publication WO 2012145099 AI, corresponding to U.S. Pat. No. 8,340,831 B2 and U.S. Publication No. 2011/0213739 A1, which provides a literature overview and indicates the complexity of conventional NILM methods, which is an obstacle to the practical application thereof. The NILM method claimed in tat document is also based on models for the individual devices having energy consumption which is monitored.

There is a need for low-complexity energy consumption determination in the industrial field.

### SUMMARY OF THE INVENTION

It is accordingly an object of the invention to provide a method, a device, a system, a computer program and a computer program product for ascertainment of process-related energy consumption information for a plurality of automated processes, which contribute to overcoming the hereinafore-mentioned disadvantages of the heretofore-known methods, devices, systems, programs and program products of this general type.

With the foregoing and other objects in view there is provided, in accordance with the invention, a method for ascertaining process-related energy consumption information for a plurality of automated processes, comprising the steps of:
obtaining energy-consumption-relevant measurement data for a plurality of processes,
determining a profile of an energy consumption of the plurality of processes using the obtained energy-consumption-relevant measurement data,
obtaining process sequence information for the individual processes of the plurality of processes,
matching the energy consumption profile of the plurality of processes and the sequence information of the individual processes,
assigning changes in the energy consumption of the plurality of processes to the individual processes based on the sequence information thereof, and
determining energy consumption information for the individual processes based on changes in the energy consumption of the plurality of processes assigned to the respective processes.

Advantageous developments are specified in the dependent claims.

The invention proposes a new procedure for ascertaining process-related energy consumption information for a plurality of automated processes. Automated processes may be in particular industrial processes. In the procedure according to the invention, energy-consumption-relevant measurement data of a plurality of processes are obtained. For this purpose, for example, energy-consumption-relevant data of a plurality of processes has been measured over a period of time and transmitted for the ascertainment of process-related energy consumption information. The measured data are, for example, current values and, where appropriate, voltage values, for example in the form of measurement series covering a measurement period. The transmitted measurement data may be processed data, for example consumption values calculated from current and voltage values. The time period is then preferably chosen in such a way that it includes at least the total duration of at least one work sequence or work step for all of the repeating work sequences of all of the processes of the plurality of processes.

An energy consumption profile (for example a profile curve) of the plurality of processes is then determined using the energy-consumption-relevant measurement data. The specific energy consumption refers in this case to all of the plurality of processes or the energy-consumption-related measurement data refer to a total consumption. The term “energy consumption” should be interpreted here as referring to a variable which is relevant to the energy consumption or energy efficiency (for example active power, reactive power, total power, etc.).

In a further step, process sequence information is obtained for the individual processes of the plurality of processes. The process sequence information can be obtained at least in part by recourse to process sequence information of a programmable logic controller which is set up to control processes of the plurality of processes.

As an alternative or in addition, the supply of process sequence information which has been generated specifically for the procedure according to the invention, for example using video recordings of individual processes or groups of processes of the plurality of processes, may be provided. The generation of process sequence information may in this case include the identification of process activities and the registration of associated time information (for example time stamps for the start or end of a process step).

In a further step, the energy consumption profile of the plurality of processes and the sequence information of the individual processes are matched, wherein this matching of the energy consumption development of the plurality of processes and the sequence information of the individual processes may include the temporal correlation of curves describing the energy consumption development or the sequence of the individual processes.

In a further step, changes in the energy consumption of the plurality of processes are assigned to the individual processes based on the sequence information thereof. This can be done using changes in the energy consumption which have been identified in the energy consumption profile. This identification of changes can be achieved using a criterion which ensures that the identified changes in the energy consumption correspond to relevant process sequence changes (for example threshold criterion for the magnitude or duration of the change). This identification of changes in the energy consumption may include dividing changes into groups, each of which may be assigned to a single process. For example, it is assumed that quantitatively identical changes can be assigned to the same process. The division into groups can also be carried out, for example, using artificial intelligence which has been trained for this purpose.

Finally, energy consumption information for the individual processes is ascertained based on changes in the energy consumption of the plurality of processes assigned to the respective processes.

The invention has the advantage of simple ascertainment of relevant energy consumption information based on measurement data (for example current and voltage) which have been recorded for all of the processes. This means that it has a low degree of complexity both with regard to the number of measuring devices and with regard to the determination of information relevant to individual processes (disaggregation).

With the objects of the invention in view, there is also provided a device which is set up to carry out a method according to the invention. The device may be, for example, a computer to which the necessary measurement data from measuring devices are transmitted. It may also be responsible for carrying out the method according to the invention for an entire production line. The device is then preferably (but not necessarily) part of the production line. In this case, the measuring devices of the production line may be configured to transmit the relevant measurement information wirelessly or via cable connection to the device, wherein the transmission may be carried out directly or via intermediate nodes.

With the objects of the invention in view, there is furthermore provided a system which comprises a device according to the invention and at least one measuring device which is set up to transmit measurement information to the device. The system may include at least one programmable logic controller, wherein the system is then configured to transmit process sequence information from the at least one programmable logic controller to the device, or the device includes a programmable logic controller. In a production line having a plurality of programmable logic controllers, one of the controllers may also be configured as a device according to the invention. The other programmable logic controllers are then configured to transmit process sequence information to the programmable logic controller acting as the device according to the invention.

The system according to the invention may also comprise a device for generating process sequence information (for example at least one video recording device, possibly with a computing unit for processing recorded video information) for carrying out a method according to the invention. Provision may also be made for the generated process sequence information to be processed or pre-processed by the device for generating process sequence information and subsequently to be transmitted to the device according to the invention.

With the objects of the invention in view, there is additionally provided a computer program which carries out a method according to the invention when the program code is executed on a computer, and a computer program product (for example a data carrier) having a computer program of this kind.

With the objects of the invention in view, there is concomitantly provided a computer program product configured to be able to be executed in at least one control unit. The computer program may be able to be stored as software, for example as an app that can be downloaded from the Internet, or as firmware in a memory and may be able to be executed by a processor or a computing device. As an alternative or in addition, the computer program may also be configured at least in part as a hard-wired circuit, for example as an ASIC (application-specific integrated circuit).

Other features which are considered as characteristic for the invention are set forth in the appended claims.

Although the invention is illustrated and described herein as embodied in a method, a device, a system, a computer program and a computer program product for ascertainment of process-related energy consumption information for a plurality of automated processes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1A and FIG. 1B are flow charts showing two alternative configurations of the methods according to the invention;

FIG. 2 is a schematic illustration of a production line;

FIG. 3 is a schematic example of a high-performance multi-process machine (for example an injection molding machine) which is, for example, part of a production line according to FIG. 2;

FIG. 4 is a diagram showing output data from an energy consumption measurement for the high-performance multi-process machine according to FIG. 3 and the detection of energy consumption change events for the output data of the energy consumption measurement;

FIG. 5 is a diagram showing a correlation of process sequence data and energy consumption data for the data according to FIG. 4 on the basis of process sequence information and the detected energy consumption change events as well as a disaggregation (decomposition) of the energy consumption data according to associated processes; and

FIG. 6 is a diagram showing an illustration of obtaining relevant energy consumption values by the disaggregation according to FIG. 5.

### DETAILED DESCRIPTION OF THE INVENTION

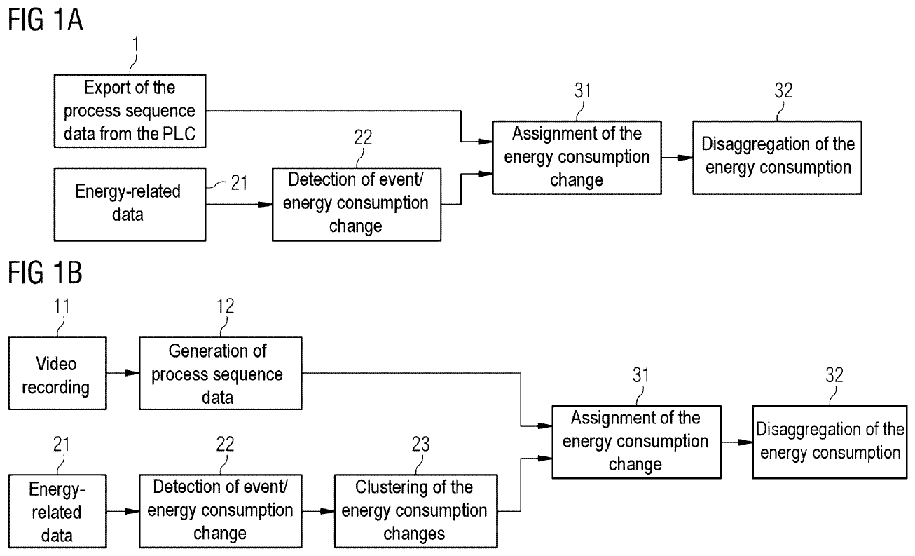

Referring now to the figures of the drawings in detail and first, particularly, to FIG. 1A and FIG. 1B thereof, there are seen conceptual representations of two different variants of the method according to the invention.

A central part of the concept according to the invention is to match process sequence information and energy consumption information to one another in order to perform disaggregation of the energy consumption information. In this case, the process sequence information may already be available or may be generated specifically for a procedure according to the invention. A combination of these two options is also conceivable, namely that existing process sequence information is supplemented by process sequence information specifically generated for the disaggregation in order to carry out the disaggregation as efficiently or completely as possible.

FIG. 1A shows the first variant. It is assumed that process sequence data which are accessed in the course of the procedure (step 1) are available (typically in a programmable logic controller). The process sequence data relate to a plurality of processes. For these processes, energy-related data (typically an energy consumption curve describing the power consumption recorded or ascertained using a measuring device) which reflect the profile of the energy consumption caused by the sequence of the processes (step 21) are collected. In a next step (step 22), changes in the energy consumption are identified (energy consumption change events). It is an important consideration of the invention that the changes can be correlated with sequence events of the processes (typically the start and end of a processing step of a process). In a next step (step 31), the change in energy consumption is therefore matched to or temporally correlated with the process sequences using the energy consumption change events. The central point here is that an energy consumption profile is correlated with sequence information of a plurality of processes, as a result of which the energy consumption change events can be assigned to a specific process by the temporal correlation. The quantitative change in the energy consumption as a result of the change in the corresponding energy consumption change event then corresponds to the effect of the associated process on the energy consumption (for example the quantitative change then represents a measure of the energy consumption of this process or of the additional energy consumption of a plurality of concurrent processes). Disaggregation of the energy consumption data (assignment of consumption components to individual processes) is thus possible (step 32).

FIG. 1B relates to a modification in the event that process sequence data are completely or partially unavailable. In this case, process sequence information is generated specifically for the procedure according to the invention. This can be done, for example, by way of a video recording of the process sequences or the devices that take the recordings (step 11), from which process sequence data are then generated (step 12). For this purpose, the recordings are analyzed, for example by identifying the start and the end of individual process steps and by setting markers or time stamps for the corresponding times. These then correspond to changes, that is to say a temporal sequence can be constructed with change events which can be assigned to specific processes. This means that process sequence data which can be correlated with the energy consumption profile of the processes are obtained.

The procedure in the second case also differs through step 23, in which the energy consumption change information is grouped together to assign energy consumption changes to process sequence data. This grouping corresponds to a division into groups associated with each process. The quantitative value of the energy consumption change, for example, is used as a criterion. This value may be subject to minor fluctuations for different energy consumption changes associated with the same process. “Minor” is to be understood here as small compared to the differences in energy consumption changes of different processes. In principle, threshold values for these minor fluctuations could be used for the grouping. In practice, however, it makes sense for complex constellations to operate using machine learning or artificial intelligence, that is to say to train a corresponding AI program (for example t-SNE, k-NN, Decision Tree, Random Forest, SVM, etc.) for the grouping.

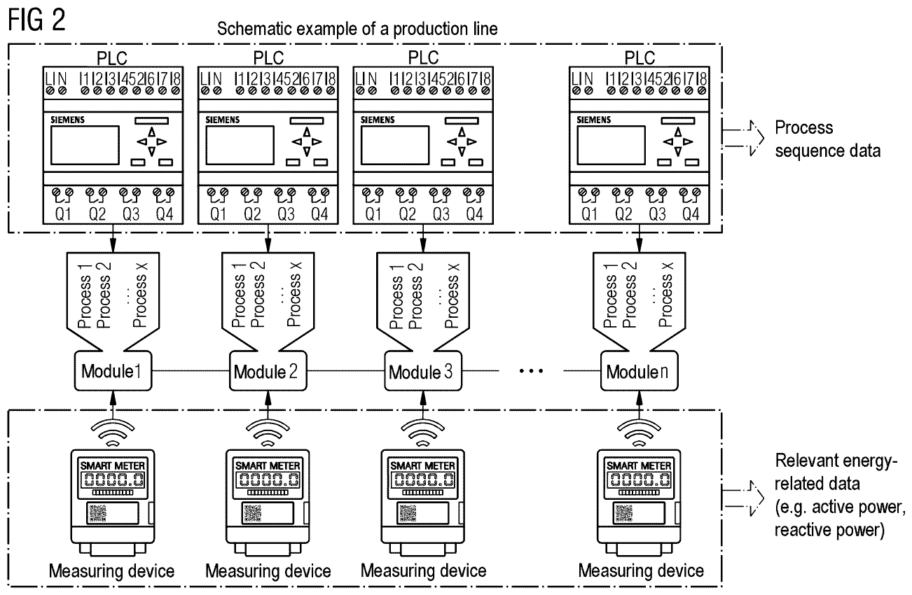

A concrete procedure is illustrated in the following text with reference to FIGS. 2-6.

FIG. 2 schematically shows a production line. The production line is formed by modules 1 to n, which are used to process workpieces, for example. In this case, the modules may be individual machines or groups of machines which each perform a number of processes. The modules are defined (or the unit “module” is defined) by the fact that, for each module, there is a separate programmable logic controller which includes the sequences of the process sequence data associated with the respective module. A measuring device is also available for each module, which measuring device records the energy consumption or relevant energy-related data (for example active power, reactive power) of the module. The measuring device may, for example, be a so-called PMD (power measurement device) which measures current and voltage, ascertains power values therefrom and transmits the same to a central location.

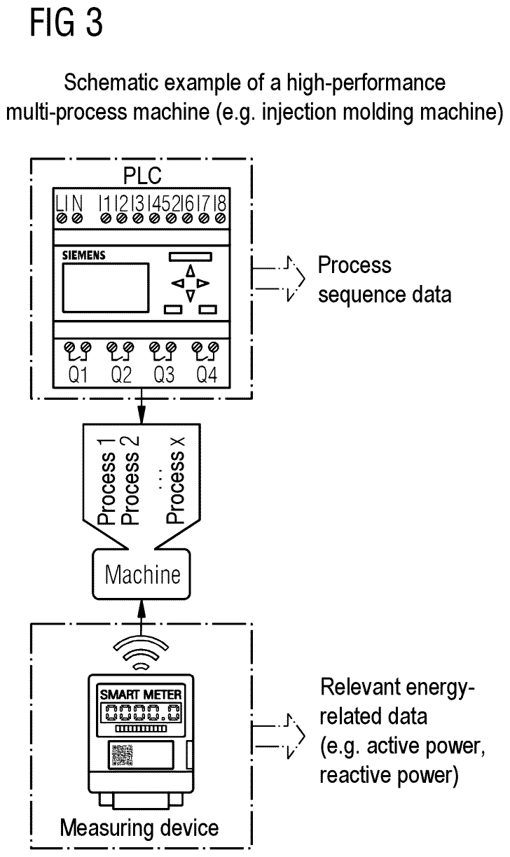

FIG. 3 shows a section of a production line according to FIG. 2. The module is in this case a high-performance multi-process machine, for example an injection molding machine, having processes which are controlled by a programmable logic controller PLC. The controller is connected to a measuring device which records the energy consumption or relevant energy-related data of the machine. The machine carries out a plurality of processes on a workpiece or for the production of a workpiece.

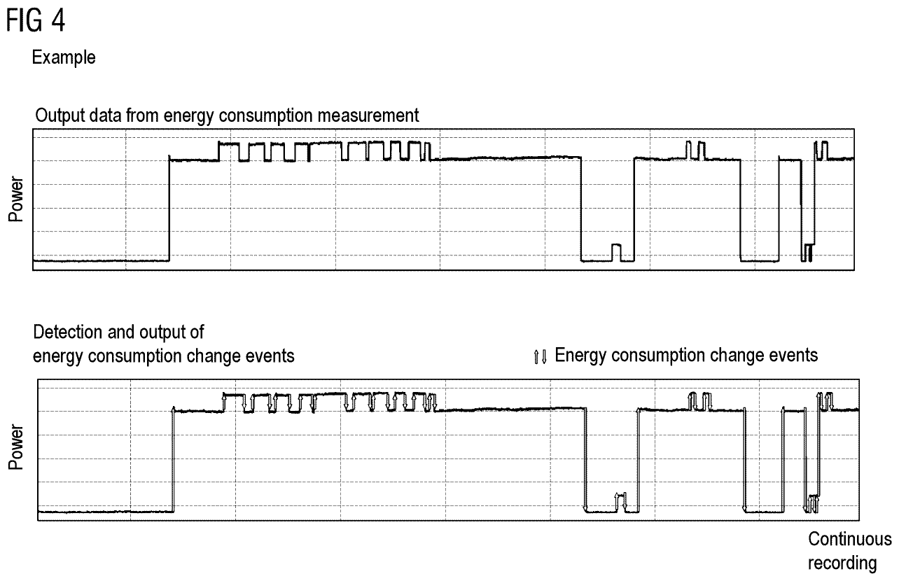

The principle of the procedure according to the invention is explained below using a simple example. For this purpose, it is assumed that the machine of FIG. 3 performs only two processes. The energy consumption data measured by the measuring device of FIG. 3 are represented by the upper curve of FIG. 4. As the next step, changes, that is to say changes in the energy consumption or change events, are identified (lower curve of FIG. 4).

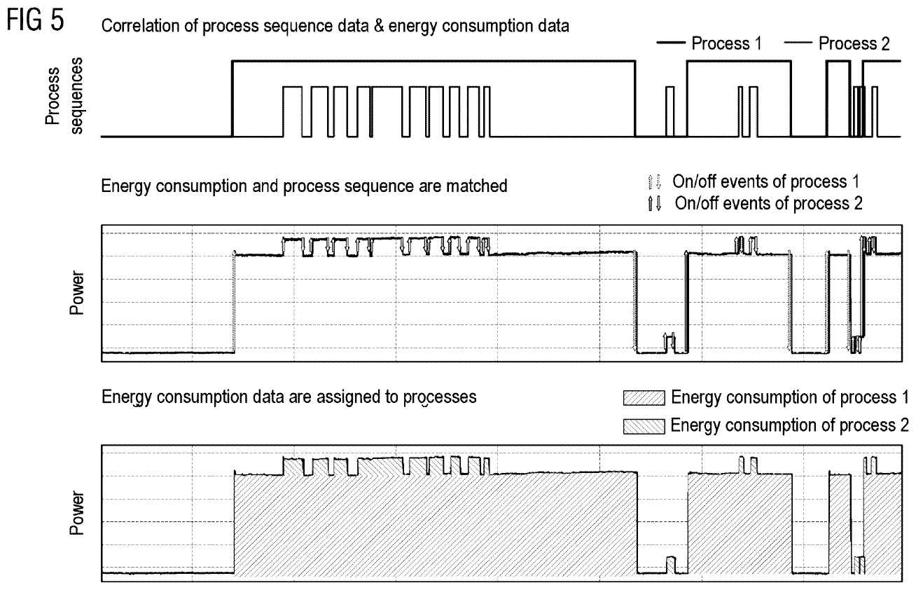

In the next step, the curve obtained in accordance with FIG. 4 is correlated with process sequence data. This is illustrated in FIG. 5. The programmable logic controller PLC extracts the temporal profile curves of the two processes. The two profiles are shown at the top of FIG. 5. The middle curve corresponds to the energy consumption curve of the machine according to FIG. 4 and does not distinguish between the two processes (total consumption). The curve is temporally correlated with the process profile curves (pattern matching), wherein the fact that consumption change events are caused by changes in one of the two processes (typically ON or OFF events) is drawn upon.

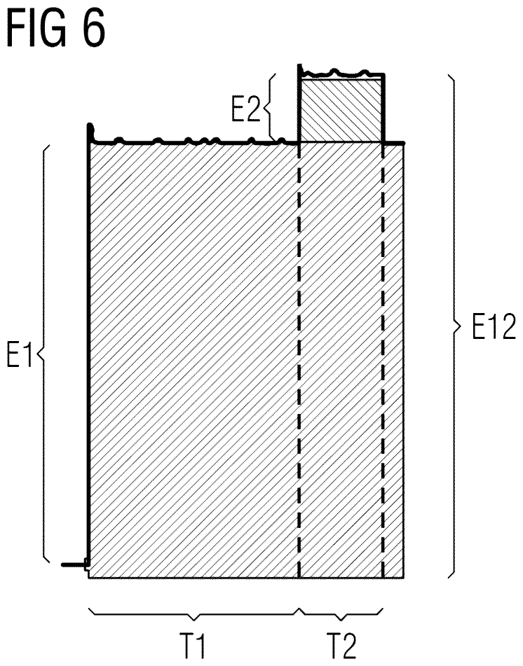

The lower curve of FIG. 5 shows the result. The consumption change events have been assigned to the two processes, which makes it possible to determine the influence of the processes on energy consumption (disaggregation of the energy consumption). For example, the consumption of the two processes adds up linearly, then the consumption of process 1 and 2 can each be determined directly. This is illustrated with reference to FIG. 6, which shows a section of the lower curve of FIG. 5.

The consumption E1 of process 1 and the consumption E2 of process 2 can be obtained in this way.

In the procedure according to the invention, if necessary, it is possible to take into consideration the fact that the situation may not be as ideal as in FIG. 3—FIG. 6, for example:
a) The consumption of different processes in a module or machine is not necessarily additive. In this case, in FIG. 6, the value E2 would correspond to the additional consumption with simultaneous execution of process 1 and process 2. The variable E12, which corresponds to the energy consumption, would then be relevant if both processes are active. If there are sections in which the two processes proceed individually, then the respective consumption in the event of only one process being active would be able to be derived on this basis. In the example described, three relevant different variables would result, namely the consumption of the individual processes when they are carried out alone and the consumption in the case of concurrent operation.
b) The energy consumption may fluctuate, especially when a machine is switched on or when machine components are connected (start of power supply) (for example due to so-called inrush currents). This transient response can be taken into account, for example by the procedure when determining the consumption by disaggregation, by taking values that are chronologically after the transient response.
c) Finally, averages can also be determined if deficits in the stability of the consumption would have a negative effect on the required accuracy of the determined values (for example averaging over time range T1 for consumption value E1 and averaging over time range T2 for consumption value E12).

The description in the course of the exemplary embodiment illustrates the principles underlying the invention. Real systems are typically much more complex. On the basis of the above description, a person skilled in the art may write a software program which also implements steps of the method according to the invention for complex systems. In particular, it is also possible to draw upon methods of machine learning in this case.

1. A method for ascertaining process-related energy consumption information for a plurality of automated processes, the method comprising:
obtaining energy-consumption-relevant measurement data for a plurality of processes;
determining a profile of an energy consumption of the plurality of processes by using the obtained energy-consumption-relevant measurement data;
obtaining process sequence information for individual processes of the plurality of processes;
matching the energy consumption profile of the plurality of processes and the sequence information of the individual processes;
assigning changes in the energy consumption of the plurality of processes to the individual processes based on the sequence information thereof; and
determining energy consumption information for the individual processes based on changes in the energy consumption of the plurality of processes assigned to the respective processes.

2. The method according to claim 1, which further comprises obtaining process sequence information at least in part by recourse to process sequence information of a programmable logic controller configured for controlling processes of the plurality of processes.

3. The method according to claim 1, which further comprises matching the energy consumption profile of the plurality of processes and the sequence information of the individual processes by correlating curves over time, the curves describing the energy consumption development or the sequence of the individual processes.

4. The method according to claim 1, which further comprises identifying changes in the energy consumption based on the sequence information of the individual processes, for assigning changes in the energy consumption of the plurality of processes to the individual processes.

5. The method according to claim 4, which further comprises dividing identified changes in the energy consumption into groups, and assigning each of the groups to a single process.

6. The method according to claim 1, which further comprises:
measuring energy-consumption-relevant data of a plurality of processes over a period of time; and
transmitting the measurement data for the ascertainment of process-related energy consumption information.

7. The method according to claim 1, which further comprises:
providing process sequence information at least in part by generating the process sequence information; and
obtaining the provided process sequence information.

8. The method according to claim 7, which further comprises generating process sequence information by using video recordings of individual processes or groups of processes of the plurality of processes.

9. The method according to claim 8, which further comprises carrying out the generation of the process sequence information by an identification of process activities and a registration of associated time information.

10. A device configured to carry out the method according to claim 1.

11. A system, comprising:
a device configured to carry out the method according to claim 1; and
at least one measuring device configured to transmit measurement information to said device;
said at least one measuring device:
measuring energy-consumption-relevant data of a plurality of processes over a period of time, and
transmitting the measurement data for the ascertainment of process-related energy consumption information.

12. The system according to claim 11, which further comprises:
at least one programmable logic controller;
the system being configured to transmit process sequence information from the at least one programmable logic controller to the device, or the device including a programmable logic controller.

13. The system according to claim 11, which further comprises:
means for generating process sequence information;
means for providing the process sequence information at least in part by generating the process sequence information, and
means for obtaining the provided process sequence information.

14. The system according to claim 13, which further comprises at least one video recording device.

15. A non-transitory computer program having a program code which carries out the method according to claim 1 when the program code is executed on a computer.

16. A non-transitory computer program product containing a computer program according to claim 15.
